(19) United States
(12) Patent Application Publication
(10) Pub. No.: US 2019/0009449 A1
(43) Pub. Date: Jan. 10, 2019

(54) CHANGING BLOW MOULDS IN BLOW MOULDING MACHINES

(71) Applicant: KRONES AG, Neutraubling (DE)

(72) Inventors: Norbert Kindl, Tegernheim (DE); Florian Geltinger, Donaustauf (DE)

(21) Appl. No.: 15/753,802

(22) PCT Filed: Dec. 19, 2016
(86) PCT No.: PCT/EP2016/081801

§ 371 Date: Feb. 20, 2018

(30) Foreign Application Priority Data
Dec. 18, 2015 (DE) 10 2015 122 324.4

(51) Int. Cl. B29C 49/48

(52) U.S. Cl. CPC B29C 49/48; B29L 2031/7158; B29C 2049/4892; B29C 2049/4858

(57) ABSTRACT

The invention relates to an apparatus for transforming plastic parisons into plastic containers, having a transport device which transports plastic parisons along a predetermined transport path, wherein the transport device has a movable station support, on which a plurality of transforming stations are arranged, wherein said transforming stations each have blow mould devices, which each have cavities within which the plastic parisons can be transformed into the plastic containers, and said blow mould devices are each arranged on blow mould supports, and the apparatus has a changing device, which is suitable and intended at least to remove the blow mould devices from the blow mould supports thereof and/or to arrange blow mould devices on the blow mould supports. According to the invention, the changing device has an identification device for identifying blow moulds and/or blow mould parts, wherein the identification device preferably has an RFID detection device.

The present invention relates to a method for operating a transforming device and in particular a changing of blow moulds of this transforming device for transforming plastic parisons into plastic containers. In addition the invention also relates to a corresponding system for transforming plastic parisons into plastic containers.

Such systems have been known for a long time from the prior art. In this case heated plastic parisons are usually transformed by the application of air pressure into plastic containers such as plastic bottles. For this purpose a plurality of transforming stations or blow stations are usually arranged on a rotatable carrier. In this case these blow stations each have blow moulds which in turn have a hollow space within which the plastic parisons are transformed into the plastic containers. In this case these blow moulds have a negative of the container to be produced. If the system is to be changed over to other containers, the individual blow moulds must be replaced. In the prior art these blow moulds are removed individually from the respective transforming stations. In this case an operator takes the individual blow mould devices out and replaces them with new blow mould devices which are intended to form the corresponding new containers. Therefore the changing process lasts a relatively long time and an operator is also necessary.

More recently changing devices have also become known which enable a partially or completely automatic changing of blow moulds. In this case, for example, blow moulds to be introduced via a magazine are provided, and a robot removes a previous blow mould and in its place introduces a new blow mould into the respective transforming station. Thus for example the blow moulds to be introduced are removed successively from the magazine. Therefore in the prior art no checking of the blow moulds takes place. Thus it may occur that an incorrect blow mould is used or also malfunctions occur, if the operator has not property equipped a changing pallet and these blow moulds are therefore incorrectly placed in a corresponding changing pallet. A checking takes place after stoppage of production of a blow moulding machine. These checking times are added to the changing times, which gives rise to a relatively long interruption of production.

Therefore the object of the present invention is to make such changing of blow moulds of the blow moulding machines more reliable. In addition, changing times for such changeovers should also be reduced.

These objects are achieved according to the invention by the subjects of the independent claims. Advantageous embodiments and modifications are the subject of the subordinate claims.

In a method according to the invention for operating a transforming device for transforming plastic parisons into plastic containers (in particular plastic bottles) in an operating mode of the system the plastic parisons are transported by means of a plurality of transforming stations along a predetermined transport path and are expanded by application of a flowable medium to form the plastic containers. In this case for expanding the plastic parisons blow mould devices are used, in the interior of which the plastic parisons are expanded to form the plastic containers. Furthermore in a changing mode at least one of the blow mould devices of the system (and/or the transforming stations) is removed and/or one of the blow mould devices is arranged on a blow mould support of the system (in particular on a blow mould support of one of the transforming stations), wherein for changing the blow mould devices a changing device is used which has a gripping device for gripping the blow mould device.

According to the invention, in an operating mode and/or during the production the transforming device is operated in a first protection region, which (at least temporarily and in particular during the operating mode or the production) is not accessible and/or cannot be reached by a machine operator (or into which the user cannot enter). The changing device is arranged at least partially in a second protection region, which is accessible for a machine operator at least temporarily in the operating mode, wherein a connection can be produced between the first protection region and the second protection region.

For safety reasons it is provided that, even in machines which are known from the prior art, in some instances protection regions are provided, for example surrounding walls, which cannot be accessed in the operating mode, so that accidents can be avoided. In order to speed up the changing operation, it is now proposed that any protection region in which the transforming device itself is arranged is not accessible in the operating mode of the transforming device and/or during the production, but any region in which the changing device is arranged is accessible. In this way preparatory operations for a changing operation can already be carried out in the operating mode. Accessing the protection region is generally understood to mean entering this protection region, and thus also reaching in with a hand or moving the head in for instance in order to be able to see specific regions of the apparatus. In particular, however, accessing involves operations which can lead to an increased danger for the user.

In a preferred method the changing device, which is configured in particular as a robot, is placed at different locations outside a protection region of the machine or the transforming device itself. The protection region can be, for example, surrounding walls which surround the machine and which prevent entry into the machine region in the operating mode. However, it would also be possible that other devices are involved which prevent a machine operator from entering the transforming device during the ongoing operation. Thus, for example, light barrier systems can also be provided to prevent access to the transforming device during the ongoing operation and, for example, cause it to be switched off if a user (or a body part of the user) passes through a light barrier. The second protection region which surrounds the changing device can, for example, involve actual walls or can also in be a light barrier system.

Therefore a protection region is understood in particular as a locally delimited region which—in particular for safety reasons—can be closed off at specific times, for instance during the machine operation.

Thus advantageously the protection region of the entire system, i.e. of the system comprising the transforming device and the changeover devices, is divided into at least two regions. As mentioned above, the first protection region is closed during the production of the containers. The second protection region, namely that of the changeover devices, can also be accessed during the container production. In a further preferred method preparation of a changing operation is carried out in an operating mode of the apparatus in the second protection region. Preparation can be understood, for example, as provision of blow mould units to be introduced, or also recognition of blow mould devices. The two protection regions preferably adjoin one another directly.

Preferably, the changing device is arranged completely inside the second protection region at least temporarily in an operating mode of the system (i.e. a mode in which plastic parisons are transformed into plastic containers). A main support on which, for example, gripping arms are arranged is preferably for instance arranged inside this second protection region. In this way specific operations which prepare for a change of blow mould, such as for instance an identification of blow mould parts, can also be carried out in the ongoing operation of the system.

In a further preferred method, for changing the blow mould device a changing device is used which has a gripping device for gripping the blow mould device, wherein this gripping device is movable in at least two different directions and/or is pivotable relative to at least three pivot axes.

Due to such a configuration, as explained in greater detail below, a very precise changing operation can be carried out.

In a further preferred method the connection between the first protection region and the second protection region is interrupted in an operating mode.

As mentioned above, the second protection region likewise again can be an actual enclosure or a light barrier system, but it would also be possible for the second protection region to be understood quite simply as the region or the environment outside the first protection region.

In a further preferred method, during the changing operation the two protection regions are at least temporarily connected to one another in such a way that the first protection region is reached at least temporarily by the changing device and/or components of the changing device. Thus preferably during the changing operation (which is in particular a fully automatic insertion and withdrawal of the blow mould devices) both protection regions are connected to one another.

In a further advantageous embodiment, in an operating mode the transforming stations are transported along a circular transport path. The transforming device advantageously has a movable and in particular a rotatable support on which a plurality of transforming stations is disposed. In the context of the changing operation new blow mould devices or blow mould devices to be inserted are advantageously mounted at least on one of the transforming stations, preferably on a plurality of the transforming stations and particularly preferably on all transforming stations.

In a further advantageous method a receiving device with (containing) a plurality of blow mould devices is introduced into a working region of the changing device. This receiving device is preferably introduced into the said second protection region. This receiving device can be for example a magazine which contains blow mould devices and/or parts of blow mould devices. It would also be possible for a plurality of magazines with blow mould devices to be introduced into the said second protection region in order thus to carry out the changing operation. In this way it is possible for not only entire blow mould devices to be replaced but also only components thereof, such as for instance the base parts or the side parts.

The blow mould devices preferably each have at least two side parts and a base part. In this case, as mentioned above, it is possible that the entire blow mould device of a transforming station is changed, but it would also be possible for only parts of the blow mould device to be changed.

In a further preferred method, in order to connect the two protection regions a common interface between the protection region is opened and in particular is opened automatically. Thus for example this interface is a folding door, a shutter or the like. It would also be conceivable that light barrier devices are deactivated for connection of the two protection regions.

In a further preferred method comprises the preparation for change comprises process steps which are selected from a group of process steps which include introduction of a mould magazine into a magazine holder of the protection region by a machine operator, closure of the second protection region, a checking/recognition process of the introduced blow mould devices and the like.

In a further preferred method blow mould parts are identified before or during the changing operation. Thus it is possible, for example, that blow mould devices or components thereof, such as for instance base parts, can be recognised by means of a recognition system. In a further preferred method the blow mould parts can be unambiguously identified. Thus it is that is not only possible to identify a specific type of blow mould devices, but also to identify a specific blow mould device or components thereof. In other words a recognition system is preferably provided which enables an individual identification of the blow mould device or parts thereof.

Due to this individual identification it is for example possible to assign specific blow mould parts to specific transforming stations. Therefore the changing device preferably performs a checking and/or recognition process. Blow mould parts or blow mould devices are advantageously identified in order to assign or to fasten these blow mould parts and/or blow mould devices to predetermined transforming stations. Thus it can preferably be established that each transforming station receives precisely one specific blow mould.

Within the context of the identification different features of the blow mould devices can be identified and/or recognised. Thus for example a required number of a blow mould device can be ascertained, and for example it can be checked whether a blow mould device 1 is located in a storage position or magazine position 1. In addition, a specific mould type can be checked, for example the internal volume thereof or the design thereof. In this way it is also possible to perform a comparison with the type selected in a respective recipe (for example it can be checked whether, if in the recipe a 0.5 l bottle is to be blown, a corresponding blow mould device has also actually been selected for producing 0.5 l bottles). In addition, in principle it can also be checked whether a blow mould is or is not present in a magazine device. Furthermore, as explained in greater detail below, it can also be examined whether a blow mould device is inserted in a correct position into the magazine. In this way a corresponding removal can take place in response later.

In a further preferred method, before or during the changing operation characteristic data for the position are assigned to the blow moulds and/or blow mould parts and in particular are assigned to the blow moulds or blow mould parts identified or to be identified. As mentioned, this can for example relate to a location inside a magazine or a situation inside a magazine. These data can also be input into a controller. Then in the removal of the blow mould devices the controller can react appropriately to this and can for example adapt gripping processes. In addition it is also possible that determined values, for example a specific situation of a blow mould device or also other values, which identify and/or characterise the blow mould device, are output.

Thus for example a display device can be provided, on which in each case the said values are output. In this case the user can check very quickly whether for example a positioning of the blow mould device is correct or also generally the correct blow mould device should be selected. These values which are identified during the testing or recognition process, such as for instance the positions of the blow mould devices, are preferably read into a control device and information is preferably also used in a changing operation, for example in order to introduce a correct blow mould number into a transforming station provided therefor, and also to do this in particular independently of a storage location of the blow mould device inside a magazine. In a further preferred method a changing operation includes as process steps at least the opening of the second protection region, the introduction of a capturing device with a plurality of blow mould parts into this protection region or into a field of action of the changing device and/or the identification of at least a part of the introduced blow mould devices or blow mould parts.

Furthermore, the present invention is directed to a system for transforming plastic parisons into plastic containers. This device has a transport device which transports the plastic parisons along a predetermined transport path. In this case the transport device has a movable (and in particular rotatable) station support disposed at least indirectly on a stationary base support on which a plurality of transforming stations is disposed. In this case these transforming stations each have blow mould devices which each form cavities within which the plastic parisons can be transformed into the plastic containers and these blow mould devices are each disposed on blow mould supports, and furthermore the system has a changing device which is suitable and intended in order, in a changing mode of the system, at least to remove the blow mould devices from their blow mould supports and/or to arrange blow mould devices on the blow mould supports. In addition the changing device has a gripping device for gripping the blow mould device.

According to the invention the apparatus has a first protection region, inside which the transforming device is operated, and furthermore the apparatus has a second protection region, inside which the changing device is at least partially arranged, wherein the first protection region and the second protection region can be made accessible independently of one another and/or the first protection region and the second protection region can be brought into an interruptible connection to one another.

It is therefore also proposed in terms of the method that separate protection regions are provided and in particular the changing device can be arranged in another protection region than the transforming device. As mentioned above, this procedure makes it possible to start preparation for a change in an operating mode of the actual transforming device.

The changing device is preferably at least temporarily located completely in the said second protection region.

In a preferred embodiment the first protection region and the second protection region are connected to one another by means of an interface, wherein this interface also enables interruption of the connection. In this case, as mentioned above, this interface can have for example folding doors, doors, sliding doors, shutters or the like.

In a further advantageous embodiment the changing device has a gripping device for gripping the blow mould device, wherein this gripping device is movable in at least two different directions and/or is pivotable about at least three different axes.

Furthermore, the present invention is directed to a system for transforming plastic parisons into plastic containers. This device has a transport device which transports the plastic parisons along a predetermined transport path, wherein the transport device has a movable station support (preferably arranged at least indirectly on a stationary base support) on which there are a plurality of transforming stations, wherein these transforming stations each have blow mould devices which each form cavities within which the plastic parisons can be transformed into the plastic containers and these blow mould devices are each arranged on blow mould supports, and the system has a changing device which is suitable and intended in order, in a changing mode of the system, at least to remove the blow mould devices from their blow mould supports and/or to arrange blow mould devices on the blow mould supports.

In an embodiment according to the invention the changing device has an identification device for identifying blow mould devices or blow mould parts.

Advantageously this changing device has at least two gripping devices for gripping blow mould devices, wherein at least one of these two gripping devices is suitable both for gripping blow mould devices formed of a plurality of blow mould parts and also for gripping individual blow mould parts. A higher variability of the transforming device or of the changing operation is achieved by this embodiment. It is pointed out that this embodiment with two gripping devices can also be used independently of the presence of an identification device. Therefore the applicant reserves the right also to claim protection for an embodiment which has no identification device but does have a changing device with at least two gripping devices.

It is therefore proposed that the gripping device can take up the blow mould devices or elements thereof in a different way. Thus for example it would be possible for the gripping device to pick up two mould sets or also to pick up the two side parts of the blow mould device as a set and a base of the blow mould device separately.

In a preferred embodiment this gripping device is movable in at least two different directions and/or pivotable about at least two different axes.

In a preferred embodiment precisely two gripping devices are provided, which for example can be arranged on a common support. Thus it would be possible that one of these gripping devices picks up a base of a blow mould and the other picks up only the side parts.

In a preferred embodiment the two gripping devices are suitable both for gripping blow mould devices formed of a plurality of blow mould parts and also for gripping individual blow mould parts. In this way a higher variability or versatility of the gripping device can be achieved.

In a further advantageous embodiment the gripping devices are of identical construction. The gripping devices preferably grip the blow mould devices only in an upper region of the blow mould devices. This is preferably an upper third of the blow mould device and in particular a section which in an installed state projects out of a mould holder or a blow mould support. Thus, for example, it is possible for the blow mould device to have projections in which corresponding engaging means of the gripping devices can engage.

Thus, for example, it is possible for the two gripping devices to remove two complete blow mould devices or, as mentioned above, parts of an individual blow mould device.

In a further advantageous embodiment the two gripping devices are arranged on a common rotatable and/or pivotable carriers. Thus it would possible, for example, for this to be delivered to a transforming station, then the first gripping device carries out an operation, then the carrier is rotated (for example by 180°) and the second gripping device carries out a further operation, for instance arranges a new blow mould device on the transforming station. In this case in a preferred embodiment the gripping device and/or this carrier is configured so that switching of the gripping devices takes place relative to a centre of the transforming stations in a circular space which is smaller than 2000 mm, preferably less than 1500 mm and particularly preferably less than 1000 mm. This carrier is preferably rotatable about an axis of rotation which extends parallel to the longitudinal directions of the blow mould devices or parallel to longitudinal directions of the containers to be expanded. In this case in a changing mode this axis of rotation can be at least temporarily vertically oriented.

Furthermore, in this procedure it would be possible for a traversing movement of the changing device or of the robot to be used in order to move a second gripper position into a changing position. In a further advantageous embodiment at least one gripping device has an actuator device in order to move a second gripper position into a changing position. Thus for example this actuator in the form of a rotational drive can rotate or pivot the said carrier, on which the gripping devices are arranged.

In a further advantageous embodiment (or the embodiment according to the invention described above) the changing device has an identification device for identifying blow mould devices or blow mould parts. Thus for example it would possible for a gripping head or the gripping device of the changing device has an RFID read and/or write module, in order to detect the type of a blow mould device and/or a number of the blow mould device. In a further advantageous embodiment each blow mould device has a corresponding read or write means, such as for example an RFID chip which unambiguously identifies the blow mould device. In this way, as mentioned above, individual fitting of the individual transforming stations with the blow mould devices is possible.

Each gripping device preferably has such an identification device. Thus for example it would be possible for the gripping device in a changing mode to be delivered to the blow mould devices, and in this case identifies these unambiguously.

In a further advantageous embodiment the identification device has an RFID detection device. Particularly preferably this detection device has a read and/or write module. In this case this reading module can in particular recognise the RFID tags on the blow mould devices. In a further advantageous embodiment at least one blow moulding device has an RDID element which can be read by the RFID detection device.

The changing device advantageously has a position detecting device for detecting a geometric position of blow moulds and/or blow mould parts. In this way, as mentioned above, an incorrect position of blow mould devices inside a magazine for example can be recognised. In a preferred embodiment this position detecting device is a proximity sensor or proximity initiator. Thus for example the gripping device of the changing device can have such a proximity initiator in order to recognise a geometric position of the blow mould devices.

In a further advantageous embodiment both gripper devices have corresponding sensors, in order to recognise correct picking up of the blow mould devices. In addition the gripper devices preferably also have actuators, in order to be able to fix the blow mould securely and in order thus to ensure secure transport. Preferably at least one gripping device and particularly preferably both gripping devices are active gripping devices, i.e. gripping devices which can carry out a driven gripping movement, for instance a movement in which one gripping element is delivered to another gripping element.

In a further preferred embodiment these said sensors and/or actuators are arranged only in an upper third of the blow mould devices or above, relative to a longitudinal extent of a blow mould device. In this way it is possible to securely grip a blow mould device arranged on a carrier arranged and to transport the blow mould device away from this carrier.

In an upper region, in particular an upper third, the blow mould device preferably has retaining means which enable retention of the blow mould device by the changing device. Thus a projection (in particular a pin) in which the gripping device can engage can be provided for example on an upper side of the blow mould device, in particular on an upper side of the two side parts of the blow mould device. In addition, in an upper region of the blow mould device a groove can be provided in which the gripping device can engage in order grip the blow mould device. This may be a first groove which is formed in a region of the first side part and a second groove which is formed in a region of the second side part. In an assembled state of the blow mould device this first groove and the second groove can preferably adjoin one another. In addition, the blow mould device can have a centring element which provides centring relative to a gripping device. In this case this centring arrangement can be formed for example as a centring cone. In this case this centring device can be arranged in particular on an upper side of the blow mould device and in particular on the surfaces of the two side parts.

In addition, the blow mould device preferably has fastening devices in order to fasten the blow mould device on a carrier, in particular a blow mould support. In this case this fastening device can be arranged for example on an outer wall of the blow mould device and in particular the side parts thereof. This fastening device s preferably also located in an upper third of the blow mould device or the side parts.

In addition, centring elements can also be located in a circumferential region of the blow mould device, for example on the circumferential walls of the two side parts. These centring elements may for example be centring pins.

In a further advantageous embodiment control means are provided which for example control actuators of the gripping devices. These may for example be control, sensor or power supply cables for the gripping device. Such lines advantageously extend at least partially inside the changing device and/or can preferably be guided by means of energy transmitters, such as for example slip rings, directly by axles of the changing device or of the robot.

Furthermore the present invention is directed to a method for operating a transforming device for transforming plastic parisons into plastic containers, wherein in a working operation of the system the plastic parisons are transported by means of a plurality of transforming stations along a predetermined transport path and are expanded by application of a flowable and in particular gaseous medium to form the plastic containers, and wherein for expanding the plastic parisons blow mould devices are used, in the interior of which the plastic parisons are expanded to form the plastic containers, and wherein in a changing mode at least one of the blow mould devices of the system is removed and/or one of the blow mould devices is disposed on a blow mould support of the system (or generally at least one blow mould device is arranged on a transforming station).

According to the invention, for changing the blow mould devices a changing device is used and at least a part of a blow mould device to be changed is identified by means of an identification device.

Therefore it is also proposed in this embodiment that an identification of the blow mould devices is carried out, in particular in order to enable an individual association of the blow mould devices with the transforming stations, even if the blow mould devices are wrongly placed in a magazine. Two gripping devices are advantageously used for changing the blow mould devices, wherein particularly preferably one of these two gripping devices is suitable and/or intended both for gripping blow mould devices formed by a plurality of blow mould parts and also for gripping individual blow mould ports (for example side parts or base parts).

In a further advantageous embodiment at least one gripping device grips at least one blow mould device in an upper region relative to a longitudinal direction of the blow mould device. This is preferably an upper third of the blow mould device. In this way the blow mould device can particularly preferably be transported suspended on the gripping device.

The two gripping devices in each case retain blow mould devices or pairs of the blow mould devices at least temporarily. Thus it is possible for both gripping devices to be equipped with a complete blow mould device at least temporarily, but it would also be possible that temporarily one of the gripping devices is equipped with first components of a blow mould device (for example side parts) and the second gripping device is equipped with another component of the blow mould device (such as for example a base part).

In a further advantageous embodiment at least one gripper device and preferably both gripper devices have sensors in order to recognise correct picking up of the blow mould device and/or actuators in order to fix the blow mould device securely. These sensor devices may for example be proximity sensors.

In a further preferred method (in particular during removal of blow mould parts) the following sequence can be carried out. Thus a first gripping device can grip only the side part (in particular in an upper third thereof) and also initially fix them and/or remove them. In a further step it is conceivable that a blow mould support opens and now the blow mould device is merely arranged on the gripping device. In a further method step the gripping device with the side parts now arranged thereon moves out of the transforming station. In the further method step the gripping devices are changed over, for example the carrier with the two gripping devices is rotated, so that now the base part of the blow mould device can be removed. The second gripping device now picks up the base part of the blow mould device (in particular below the shaping region for a container). In this way any region which shapes the container is treated carefully.

In a further preferred method the blow mould devices are removed from the transforming stations, wherein a removal movement perpendicularly to a longitudinal direction of the blow mould parts takes place at least temporarily. Thus in particular it is possible that before a changeover of the gripping device, for example before a rotation of the carrier on which the blow mould devices are arranged, a movement of the gripper holder takes place which is substantially radial relative to the centre of the blow moulding machine and perpendicular relative to a principal axis of the mould support, in order to remove the old mould from the blow mould support.

Furthermore, in this case, as mentioned above, it is possible for a traversing movement of the changing device to be used in order to bring the second gripping device into a position.

Thus in a preferred method the side parts and the base part of the blow mould device are removed successively over time from the blow mould device.

In a further preferred method the changing device sets down an old mould and picks up a new mould, whilst the blow mould support closes and/or locks and/or the transport device moves further, in particular the blow moulding wheel rotates further. In this way the overall changing times can be reduced.

In a further preferred method at least one gripping device is equipped alternately with a blow mould device to be removed from the transforming station and a blow mould device to be arranged on the transforming station. In this case, as mentioned above, during this changing operation the transport wheel can rotate further, in particular while an old mould is set down and a new mould is removed.

In other words it is conceivable, that a gripping device s alternately equipped with the old mould and the new mould, in order to avoid a changeover of the gripping devices, for example when setting down the old mould and picking up the new mould.

In a further advantageous embodiment the gripping devices are designed in such a way that interfaces to pick up the blow mould devices relative to the centre of the gripping devices are configured in a mirror image. In this way identical blow mould devices can be gripped by identical gripping devices.

In a further advantageous embodiment a control device controls the gripping device in such a way that initially an old mould is set down in a free position of a receiving device such as a magazine, and relative to the most recently removed old mould the numerically next new mould (for example in the event of chaotic storage) is removed from the magazine. If the blow mould devices are removed in parts, for instance first of all the side parts and then the base part, it is possible for the base part to be set down in a separate magazine. This magazine preferably has receiving positions in the form of a matrix.

In a further advantageous method the base parts of the blow mould device are turned with respect to an axis which is perpendicular to a longitudinal direction of the containers to be transformed. In particular, such turning takes place after the removal from the transforming stations. The base parts of the blow mould devices are set down in a magazine with a shaping side, i.e. the surface which produces the container, towards the bottom in a magazine. In this way these surfaces can be better protected.

In a further advantageous embodiment interfaces of the gripping device are designed in such a way that substantially vertical transport of the blow mould devices takes place without pivoting or tilting them (relative to their original position in the mould holder). It is preferably possible that the base parts are rotated after the removal from the mould holder and before being set down in the magazine. This rotary movement is advantageously carried out by the changing device or the body itself or also by an actuator on the gripping device.

In a further preferred method a higher-level control controls a changeover of the gripping devices in such a way that it uses information from the input of the mould positions from the magazine (for example by means of RFID) and/or recipe information in order to change them over appropriately.

However, the changing device preferably moves within a limited working range. This means that in particular the removal and delivery movement for the blow mould devices takes place in a limited working range. In reaction to the external forces a position can deviate from this working range. Otherwise, however, this defined working range is preferably maintained, in particular during a mould change.

In this case it is advantageously possible that the working range of the changing device is limited from the point of view of safety and in particular mechanically. Such a limitation would be possible by different measures, for instance by light barriers, which detect an incorrect or excessive movement of the changing device and consequently effect either a return or an emergency stop of the changing device. In addition, however, a limitation of the working range by mechanical elements, such as for example stops, would also be possible.

Further advantages and embodiments are disclosed by the appended drawings.

In the drawings:

FIG. 1 shows a schematic representation of a system according to the invention;

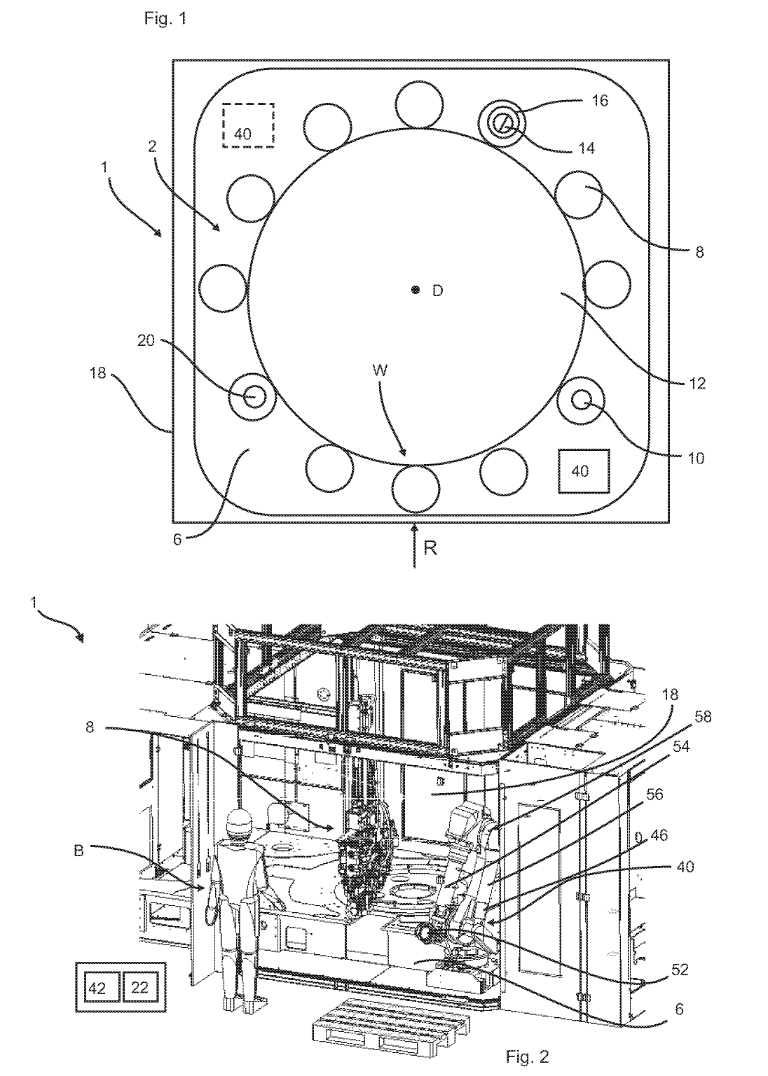

FIG. 2 shows a representation of the system with illustrated changing device;

FIG. 3 shows a plan view of the system shown in FIG. 2;

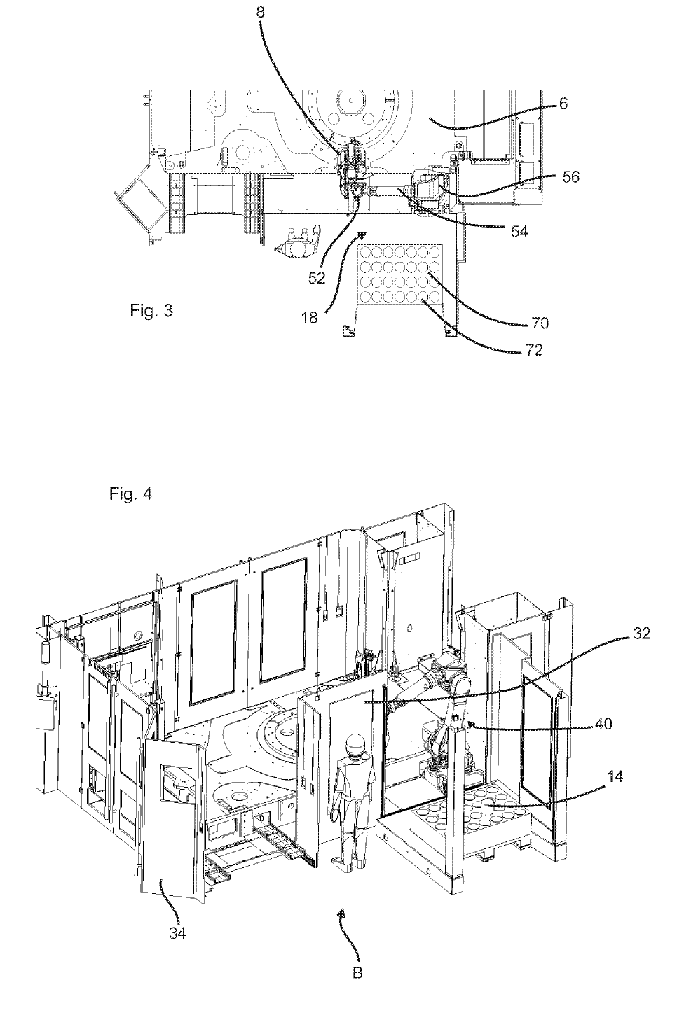

FIG. 4 shows a further representation of the system shown in FIG. 2;

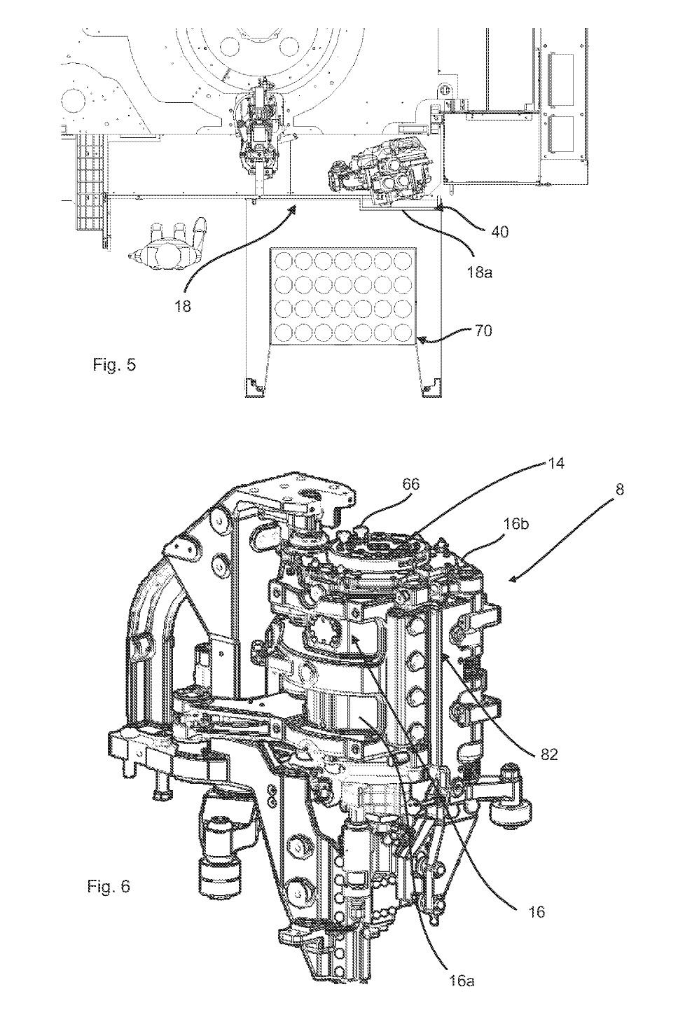

FIG. 5 shows a further representation of the system shown in FIG. 2 in a further operating position;

FIG. 6 shows a representation of a transforming station;

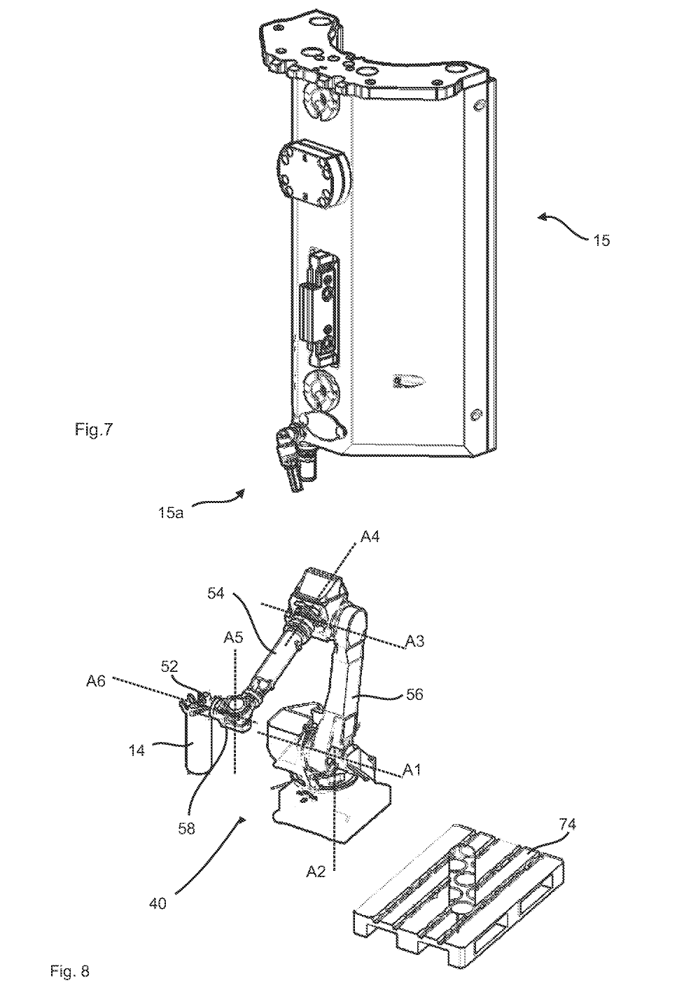

FIG. 7 shows a representation of a mould shell for a blow mould device;

FIG. 8 shows a representation of a changing device;

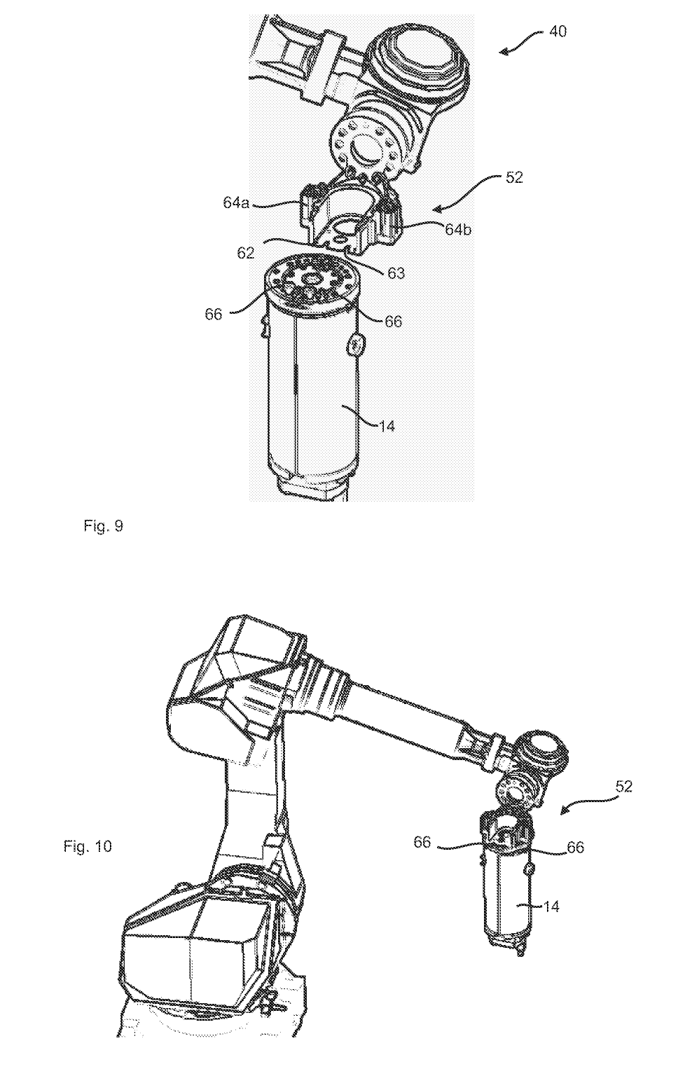

FIG. 9 shows a representation of a gripping device for gripping a blow mould device;

FIG. 10 shows a representation of a changing device with a blow mould device;

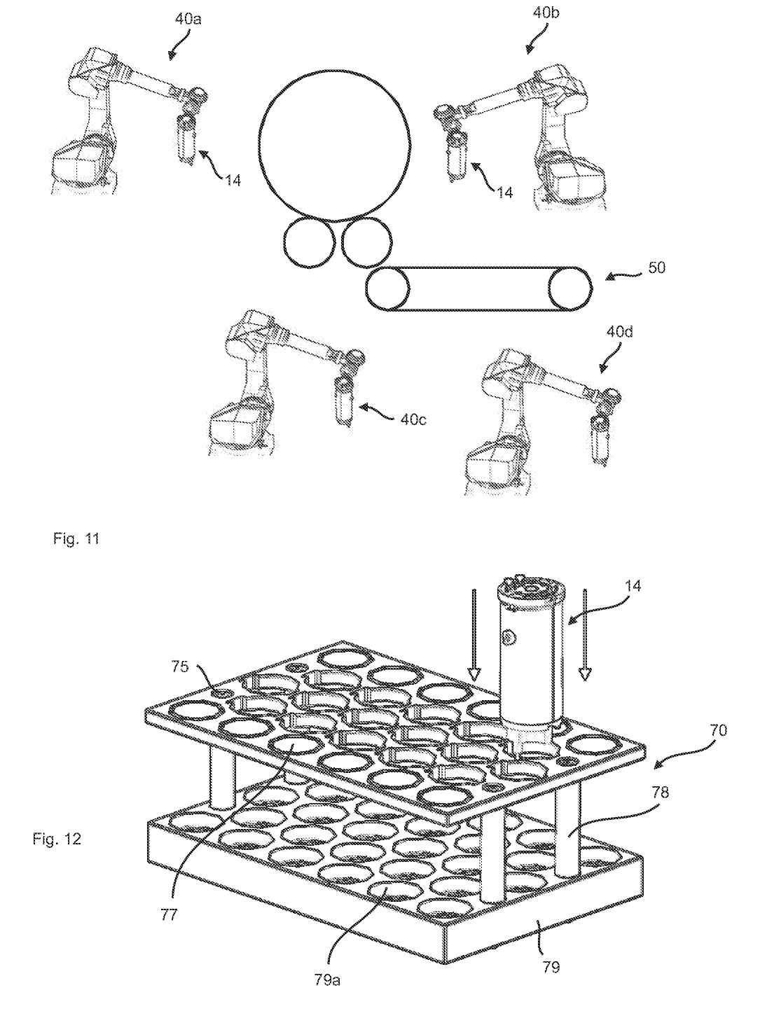

FIG. 11 shows a representation for illustration of possible positions of the changing device;

FIG. 12 shows a representation of a magazine with a blow mould device;

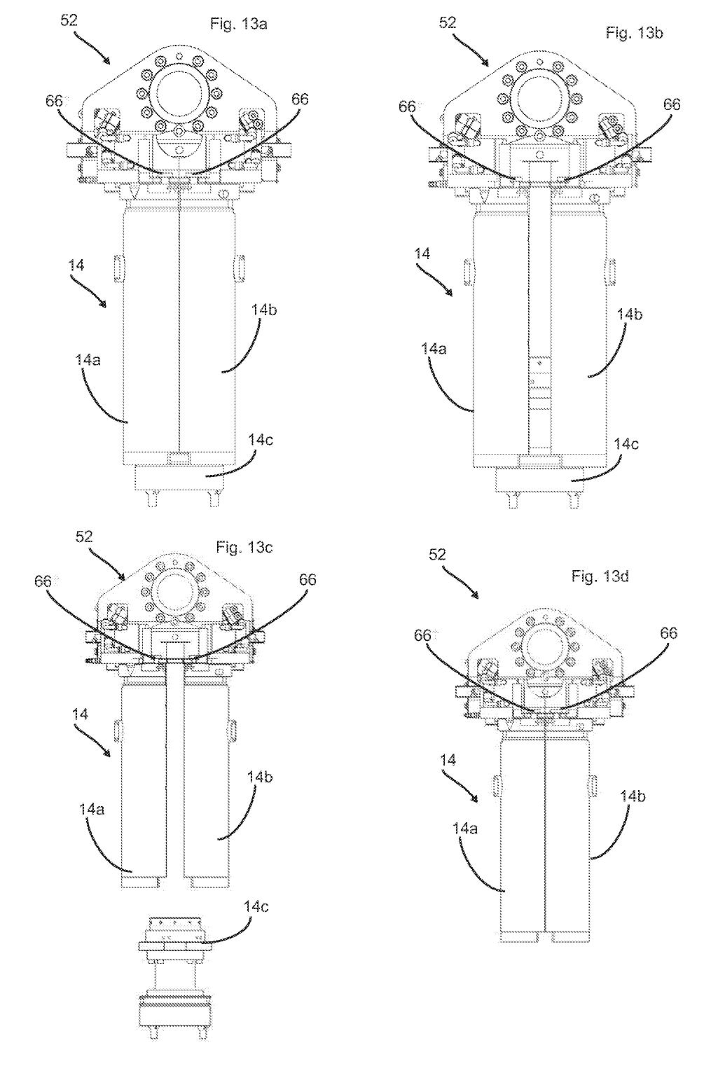

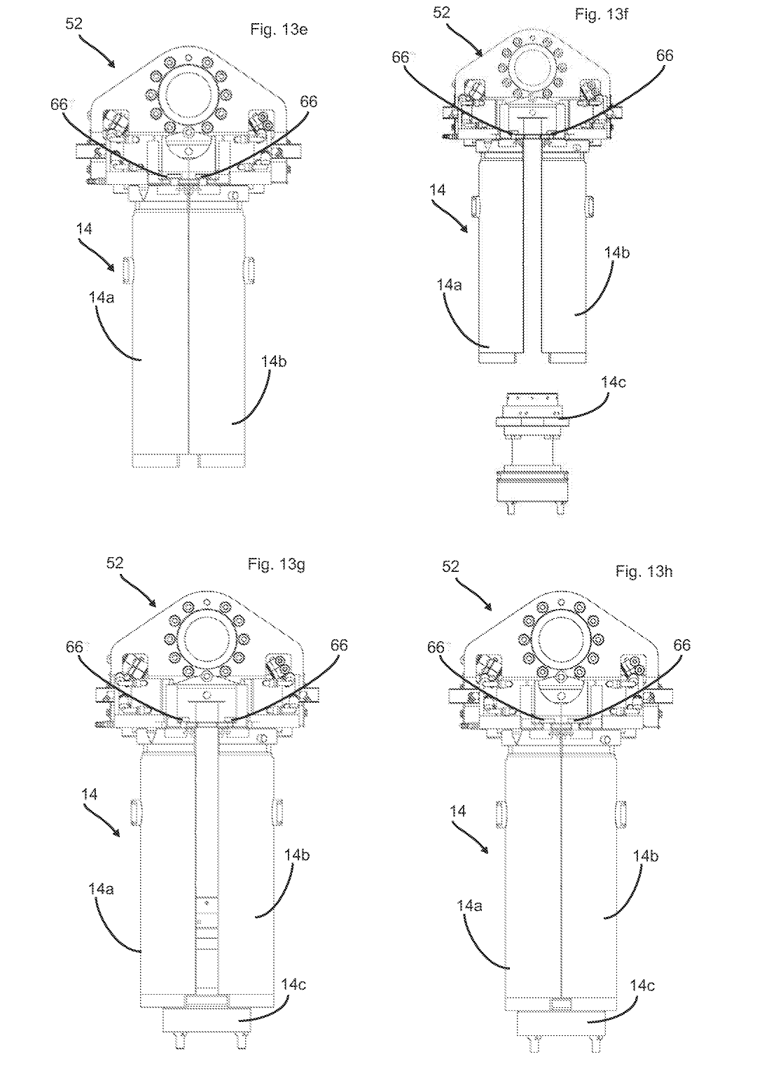

FIGS. 13a-13 h representation for illustration of a partial change of a blow mould device;

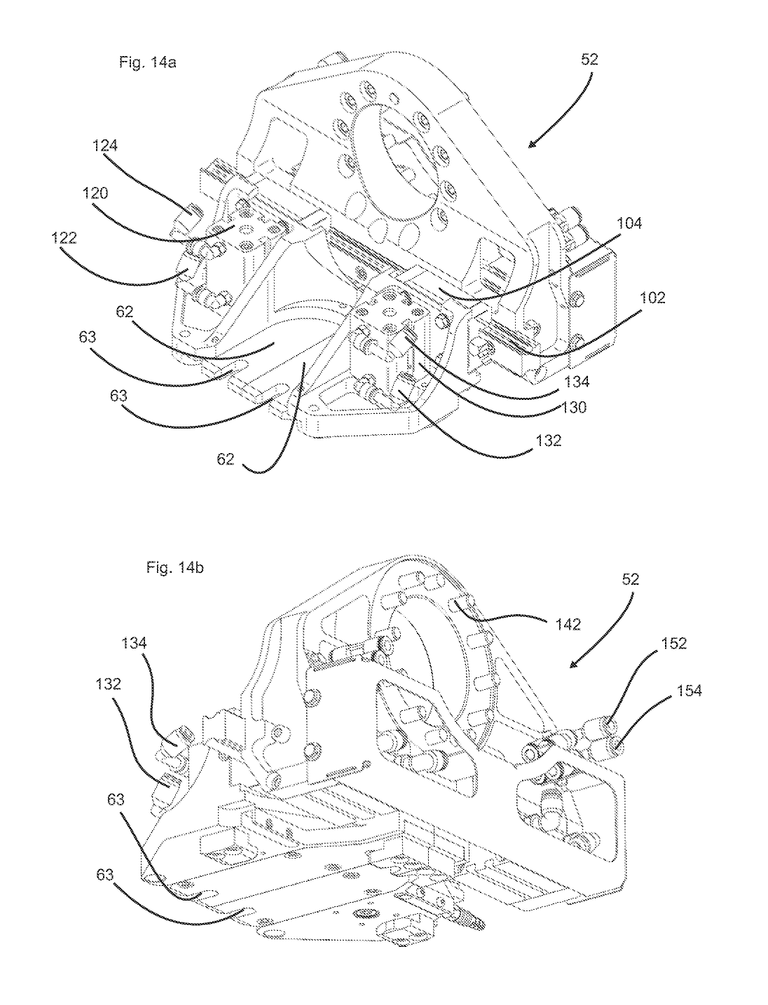

FIGS. 14a, b show two representations of a gripping device;

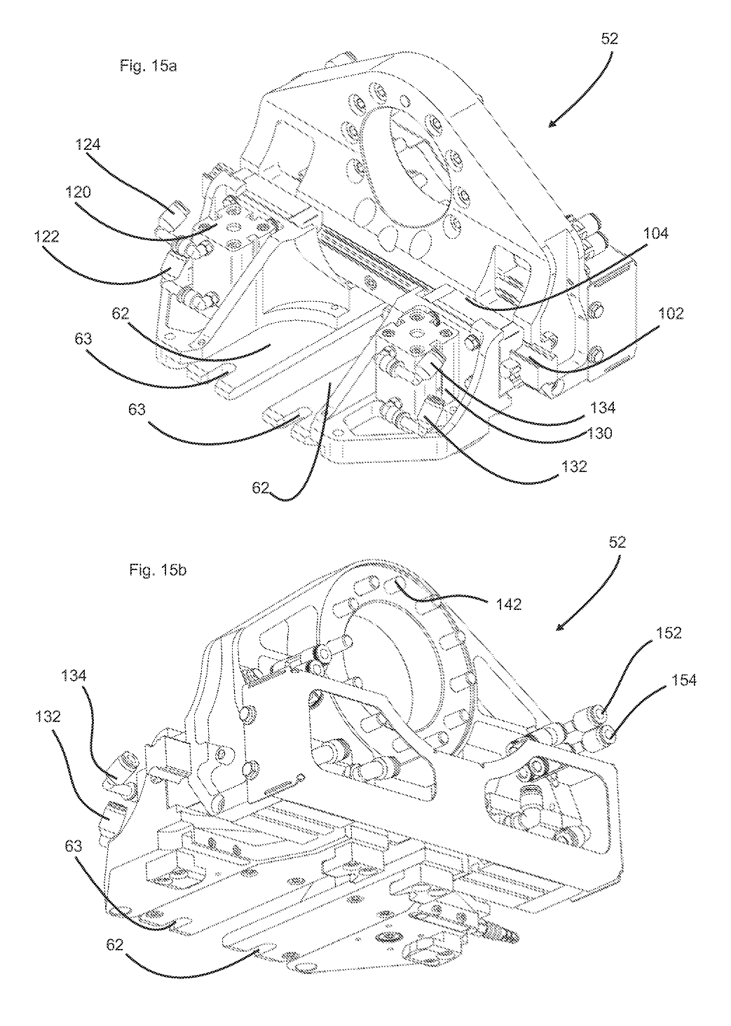

FIGS. 15a, b show two further representations of a gripping device;

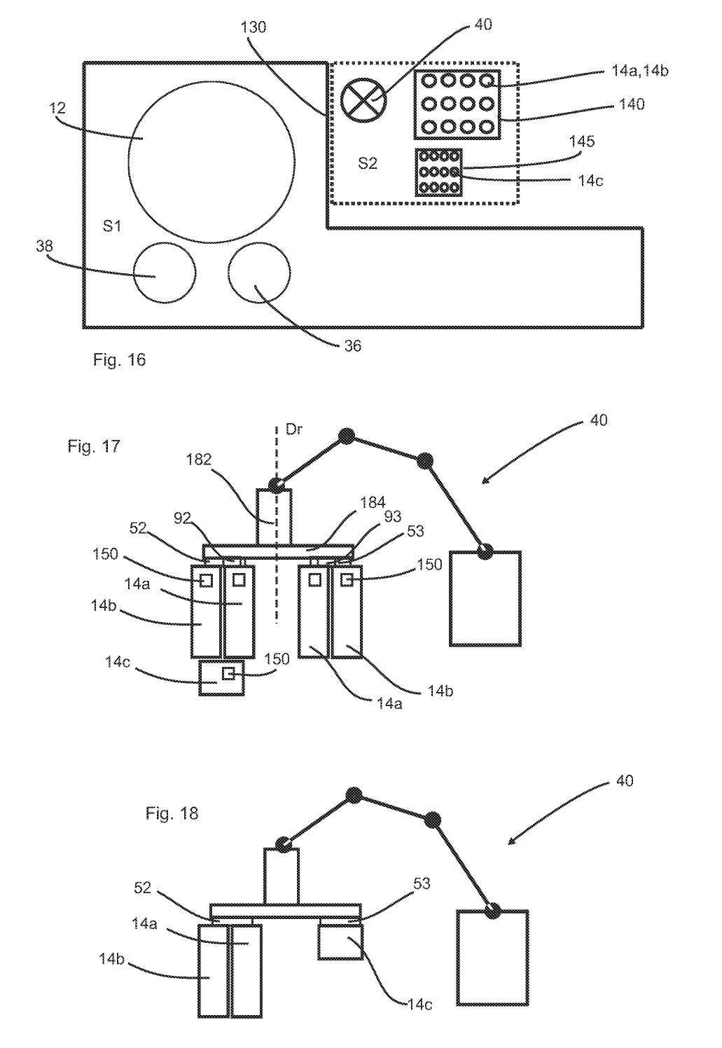

FIG. 16 shows a representation of a system according to the invention with two protection regions;

FIG. 17 shows a representation of a changing device with two gripping devices; and

FIG. 18 shows a representation of the gripping device according to FIG. 17 in another state of occupation.

FIG. 1 shows a schematic representation of a system 1 for transforming plastic parisons into plastic containers. In this case the plastic parisons are delivered to the individual transforming stations 8 and expanded to form plastic containers 20. After this expansion the plastic containers removed again from the system. For this purpose a delivery starwheel can be provided which delivers the plastic parisons to the system 1 and also onto a discharge device, in particular likewise a transport starwheel, which discharges the finished containers from the system. The system 1 has a station support 12 on which a plurality of transforming stations 8 are disposed. This station support may be for example, as shown in FIG. 1, a blow wheel which is rotatable with respect to an axis of rotation D (which here extends perpendicular to the drawing plane and thus vertically). Each individual transforming station has a respective blow mould device 14. This blow mould device 14 is composed of two side parts and a base part. These blow mould devices can be replaced according to the invention. In this case the blow mould devices 14 are disposed on blow mould supports 16 arranged and can be removed therefrom or disposed thereon.

The reference sign 40 identifies a changing device which serves to remove the blow mould devices from their blow mould supports or to dispose the blow mould devices on the blow mould supports. The reference sign 6 identifies a base support on which the station support 12 is rotatably mounted. The changing device 40 is also disposed on or adjacent to the base support 6. Thus the changing device 40 can be integrated in the system. The reference sign 18 identifies a housing, which at least partially surrounds the station support 12, but which preferably, as shown below, can also enclose or house the changeover device 40.

The reference sign W designates a changing position. As mentioned above, the blow mould devices are preferably replaced at a specific changing position. This means that the transforming stations can be moved successively into this changing position W by a rotation of the support 12 and then at this changing position the old blow mould devices can be removed and preferably also new blow mould devices can be delivered. The reference sign R designates a radial direction. In this radial direction the changing device or a gripping device of the changing device is preferably delivered to the transforming stations or the blow mould devices in order to change them.

FIG. 2 shows a perspective representation of a system 1, which merely shows a transforming device or transforming station 8. The station support on which this is disposed is likewise not illustrated here. Furthermore the base support 6 can be seen, on which the changing device 40 is disposed. This changing device 40 has a first swiveling arm 56 as well as a second swiveling arm 54. By means of an articulation and driving connection these two arms can be connected to one another so as to swivel.

The reference sign 52 designates a gripping device which serves in order to grip and to transport the blow mould devices. This gripping device is in turn disposed so as to swivel on the second arm 54 and is preferably also rotatable. Thus overall the gripping device can swivel about at least three, preferably about at least four axes in space. In addition it would also be possible, as illustrated by the rectangle shown by a broken line, that a plurality of changing devices are provided, wherein these are in particular disposed in each case at least indirectly on the base support 6. In this way the individual blow mould devices could be replaced more quickly in a changing operation.

The reference sign 46 identifies schematically a detecting device which detects forces acting on the changing device 40 or the gripping device 52 in order thus to switch off in an emergency. The system advantageously has a plurality of such detecting devices, wherein preferably each one is associated with an individual driving device which effects a movement of the changing device 40 or of the gripping device 52. These detecting devices may for example be force measuring devices which actually determine forces, torques and the like. However, it would also be possible that the forces are determined from parameters of the respective drive, for instance from flows or the like.

The reference sign B identifies a user who operates the system. Advantageously during operation of the changing device the user cannot move in regions which can be reached by the changing device 40.

The reference sign 22 identifies a control device for controlling the changing device. The reference sign 42 identifies a control device for controlling the transforming device. In this case these two control devices can interact with one another, in particular for a changing operation for replacement of the blow mould devices. In this case it is possible that in a normal working operation of the system the changing device 40 moves into a rest position in which the changing device occupies the least possible space.

FIG. 3 shows a plan view of the system shown in FIG. 2. It will be recognised here that the changing device 40 is likewise integrated into the housing 18. In the state shown in FIG. 3 the arm 56 is just swiveled out, so that the gripping device 52 can just grip a blow mould device.

In addition a magazine device 70 is also illustrated which has a plurality of receiving points 72 for receiving the blow mould devices. In this case these blow mould devices can each be moved into the receiving points or holes 72.

FIG. 4 shows a further representation of the system according to the invention. It will be seen that here a wall 32 is provided which separates the user B from the changing device 40, so that the user cannot be injured. In addition further movable wall parts 34 can also be provided, so that on the one hand the machine is more easily accessible for maintenance purposes, or on the other hand further changing devices can also be provided, as also illustrated in FIG. 1.

The representation shown in FIG. 5 is similar to the representation shown in FIG. 3, but here the changing device 40 is in a different operating position. This may for example be a working operation in which the system transforms plastic parisons to form plastic containers. It will be recognised that a recess 18a which also serves to completely receive the changing device 40 can be disposed in the housing 18. In the state shown in FIG. 5 the individual arms of the changing device 40 can be hinged inwards so that the changing device 40 occupies only a small space.

FIG. 6 shows a representation of a transforming station 8. The blow mould support 16 can be seen here which can have two blow mould support parts 16a, 16b which can swivel apart in order to open and to close the blow mould device 14. Also for the changing operation the two blow mould support parts 16a, 16b can be swiveled apart, in order to be able to remove the blow mould device 14.

The reference sign 82 designates as a whole a locking device which in the working operation locks the two blow mould support parts 16a and 16b to one another, so that even with greater pressures they do not swivel apart. The reference numeral 66 relates to a projection which in each case is disposed on the two side parts of the blow mould device 14. This projection is designed to be so stable that the entire blow mould device 14 can be supported on this projection. In this case the gripping device or a component of the gripping device can engage behind this projection 66, so that the gripping device 52 can support the blow mould device by means of this projection. By means of holding of the respective side parts of the blow mould device on the projections 66 the blow mould device in its entirety can also be held together.

FIG. 7 designates a blow mould support shell. This blow mould support shell 15 can be disposed on the blow mould support 16 and in turn can itself receive the blow mould device or parts of the blow mould device. In this case delivery and discharge elements 15a can be provided, in order to deliver media, such as for example temperature control media, to the blow mould shell 15.

FIG. 8 shows a further representation of the changing device 40. This shows the first arm 56 which can be swiveled with respect to a first axis A1. In addition, however, this arm 56 is also rotatable with respect to a second axis A2. A second arm 54 is disposed on this first arm 56 and in this case the arm 54 can swivel with respect to an axis A3 relative to the first arm 56. Here the two axes A1 and A3 are parallel to one another. However, these axes can also be disposed obliquely or aslant relative to one another. In addition, however, the second arm 54 is also rotatable with respect to a fourth axis A4.

In order to achieve this respective swiveling and rotary movement with respect to the individual axes and also with respect to the further axes to be described, in each case driving devices, such as in particular, but not exclusively, electric motor-powered drive units can be provided. In addition, however, it would also be conceivable to use pneumatic and/or hydraulic drive units. A gripping device 52 which serves for gripping the blow mould device is provided on the second arm 54. In this case this gripping element can swivel with respect to an axis A5 relative to the arm 54. This axis A5 may be perpendicular to the axis A3 and/or also perpendicular to the axis A4. In addition the gripping device is disposed on the arm 54 via a support 58. The gripping device itself can in turn be rotatable relative to this support 58 with respect to an axis A6.

By means of this plurality of movements the blow mould devices 14 can be removed from the individual transforming stations and placed onto a support 74 which is shown here as a Europallet. However it would also be possible to introduce the blow mould devices 14 directly into openings provided in a magazine.

In this case the distance between the magazine device or the pallet 74 and the changing device 40 can be between 1 metre and 2 metres. Also a corresponding radius of action of the changing device may be in the region of 1.5 metres.

FIG. 9 shows a detail of the changing device 40 or the gripping device 52 thereof. This gripping device may have a guide element 62 which can be guided over a corresponding surface of the blow mould device. In addition projections 64a, 64b can also be provided which serve for centring the changing device 40 or precisely the gripping device relative to the transforming station. The reference sign 63 relates to a recess which is disposed in the guide element 62 and can engage behind the projections for changing the blow mould device. Thus the guide element 62 also serves for supporting the blow mould device 14.

FIG. 10 shows a view of the changing device with a blow mould device 14 disposed thereon. It will be seen that the gripping arm 52 here engages in two projections 66 which are disposed on the blow mould device 14 and presses these together, so that in this way the blow mould device is held together. Thus the projections 66 also shown in FIG. 9 and FIG. 6 which are disposed on the blow mould device 14 serve to hold it together during transport. Thus advantageously above the blow mould device 14 the gripping device 52 engages in elements thereof in order to hold it. This type of engagement in the blow mould device is suitable in a special manner since the blow mould device, as is also shown in FIG. 6, projects beyond its support and in this way can also be gripped in a closed state of the blow mould support 16. Thus it is possible that the changing device or the robot initially grips the blow mould device 14 by means of the projections 66 thereof and only then the blow mould support is opened. In this way it can be ensured that the blow mould device is held securely at any time.

FIG. 11 shows a further representation of the present invention. Here a plurality of changing devices 40a-40d are provided, by which in each case elements of the system can be changed. In this case it would be possible for example that two of the changing devices (40a, 40b) are provided, in order to change blow mould devices 14, but that also further changing devices are provided which replace other elements such as for example heating mandrels which are located in a kiln 50 for heating the plastic parisons (the changing device 40d). In addition, for example holding elements, such as transfer tongs, which transport the plastic parisons after heating to the transforming device 1, can be changed by means of the changing device 40c.

FIG. 12 shows a receiving arrangement such as a magazine to receive the blow mould devices 14. This may contain a support plate 75 which has a plurality of openings 77. By means of supports 78 this plate 75 can be arranged on a base support 79, wherein this base support 79 in turn has openings 79a or holes to receive the blow mould devices.

Advantageously this magazine has the same dimensions as a so-called Europallet and thus preferably dimensions in a range of 1200×800 mm. In this case the individual openings 79a are, as shown in FIG. 12, disposed in rows and offset from one another, so that the greatest possible number of blow mould devices can be introduced into the pallet.

FIGS. 13a-13h illustrate a changing process for a blow mould device, in which the complete blow mould device should not be changed, but only the side parts. In the representation shown in FIG. 13a a complete blow mould device 14 is arranged on a gripping device 52. Here the gripping device 52 removes the entire blow mould device. i.e. both the two side parts 14a and 14b and also the base part 14c, which is mechanically coupled to the side part 14a and 14b, from the blow moulding machine. In a further step the entire blow mould device 14 is set down or arranged on a storage place (not shown) for the base part 14c. In a further process step the gripping device 52 opens, as illustrated in FIG. 13d. For this purpose two retaining elements of the gripping device 52 which are explained in greater detail below can be apart, in order thus also to move the two side parts 14a and 14b apart.

In the situation illustrated in FIG. 13c, the gripping device 52 with the side parts 14a and 14b still arranged thereon moves upwards. The base part 14c remains at its storage place. In the situation illustrated in FIG. 13d the two side parts 14a and 14b are shown set down in a corresponding store (not shown). Furthermore, as shown in FIG. 13e, new side parts 14a and 14b are shown removed from the store (not shown). In the situation shown in FIG. 13f these two side parts are moved apart again and, with the gripping device correspondingly opened, are placed above the old base part 14c. This situation is also shown in FIG. 13g. In this situation the two side parts 14a and 14b have been moved downwards and during the subsequent closing of the gripping device 52 the old base part of the two blow mould side parts 14a and 14b is picked up.

Lastly, the new side parts 14a and 14b as well as the original base part 14c can be fastened again to a mould support (not shown), as illustrated in FIG. 13h.

The drawings 14a and 14b show a representation of a gripping device, which is also suitable and intended for moving the two side parts apart, in order thus to release the base part. In this case FIG. 14a shows a view from above of the gripping device and FIG. 14b shows a view from below. It will be seen that this gripping device 52 again has the two guide elements 62, in which the cutouts 63 to receive the projections 66 arranged on the side parts are arranged. However, whereas in the embodiment described above this guide element 62 was formed in one piece, in this case two such guide elements 62 are provided which can be moved apart. For this purpose these guide elements 62 (and thus also the cutouts 63) are in each case arranged by means of a carriage 104 on a carrier 102 and can be moved relative thereto. The reference numeral 120 relates to a first driving device, in order to move the guide element shown on the left in FIG. 14a and the reference numeral 130 relates to a driving device in order to move the guide element 62 shown on the right in FIG. 14a. The reference numerals 122, 124, 132 and 134 designate communication connections for connecting a hydraulic or pneumatic medium. In FIG. 14b retaining elements 142 are illustrated, for fastening the gripping device 52 to an arm. In addition, further connections 152, 154 are provided for hydraulic or pneumatic media, in order also to effect further degrees of freedom of movement, such as for instance a pivoting of the guide element 62 as a whole or also linear displacements.

In the embodiments illustrated in FIGS. 15a and 15b the guide elements 62 are moved apart or moved away from one another. Accordingly the side parts, of which the projections rest in the cutouts 63, are also spaced apart, so that—as explained with reference to FIGS. 13a-13h—the base part can now be removed from the side parts.

Thus in this embodiment the gripping device 52 enables a relative movement between the guide elements 63 or retaining elements 62, which serve for retaining or guiding the side parts 14a, 14b of the blow mould device 14. In this case the two guide elements 62 are in each case movable in a rectilinear direction, in order thus to distance the side parts of the blow mould device from one another or to advance them towards one another.

As mentioned above the drives for carrying out this moving of the side parts apart and together are preferably pneumatic drives. Standard magazines can be used as the magazine for storing the blow mould devices.

FIG. 16 shows an embodiment of a system according to the invention. In this case the transforming device 1 is again illustrated with the rotatable carrier 12. In addition, a delivery device 36 is also provided for supplying the plastic parisons, for instance in the form of a transport starwheel as well as a discharge device 38 for discharging the finished plastic containers or plastic bottles.

The reference numeral S1 relates to the first protection region, inside which the transforming device 1 is arranged. The reference numeral S2 designates the second protection region, inside which the changing device 40 is arranged. The first protection region S1 is separated from the second protection region S2 by a separating element 160. This separating element 130 (for instance in the form of a shutter) can produce or interrupt a connection between the two protection regions S1 and S2. During operation it is conceivable that the first protection region S1 is closed and the second protection region S2 is opened.

The reference numeral 140 relates to a first magazine device, in which in this case a plurality of first side parts 14a and second side parts 14b of blow mould devices is arranged. In this case these side parts preferably have identification elements in order to be able to be identified unambiguously by the changing device.

The reference numeral 145 identifies a second magazine device in which the base parts 14c of the blow mould devices 14 are arranged. These base parts 14c are preferably also unambiguously identifiable.

FIG. 17 shows a representation of the changing device 40. In this embodiment two gripping devices 52, 53 (not shown in detail) are provided, wherein on one gripping device 52 the two side parts 14a and 14b are arranged as well as also the base part 14c. Thus in this case the entire blow mould device 14 is arranged on the gripping device.

In the case of the second gripping device 53 only two side parts 148 and 14b are arranged on the gripping device. The reference numeral 182 designates a holding device on which the two gripping devices are arranged. Furthermore, a carrier 184 is provided which serves for carrying the two holding devices. In this case this carrier can be rotated with respect to an axis of rotation Dr, in order to selectively advance the first gripping device 52 or the second gripping device 53 for instance towards the transforming stations.

The reference numerals 92 and 93 each relate to identification devices which serve for identification of blow mould parts. These identification devices may for example be RFID reading devices which are suitable for reading RFID tags. These identification devices here are arranged on the gripping devices, but they could also be arranged on the carrier 184. On the individual blow mould parts 14a, 14b, 14c identification elements 150 can be arranged enable an unambiguous identification of the individual blow mould devices. These identification elements may for example be RFID tags or the like. Furthermore, the system preferably has a storage device (not shown), in which input data, for instance data which characterise the blow mould devices, can be stored.

In this case it would be possible to store such data which characterise the blow mould devices, together with positional data of the gripping device store, so that it is possible to ascertain the location (for instance inside a magazine) where a specific blow mould device is currently located.

In the embodiment illustrated in FIG. 18 two gripping devices 52, 53 are likewise provided, but here one gripping device 52 serves for gripping the two side parts 14a and 14b of the blow mould device and the other gripping device 53 merely serves for gripping a blow mould. As stated, however, each of the two gripping devices 52, 53 is intended as required only for gripping the side parts, only for gripping a base part or for gripping an entire blow mould device comprising two side parts and a base part.

The applicant reserves the right to claim all the features disclosed in the application documents as essential to the invention in so far as they are individually or in combination novel over the prior art. Furthermore it is pointed out that features which may be advantageous per se have also been described in the individual drawings. The person skilled in the art recognises immediately that a specific feature described in a drawing may also be advantageous without the incorporation of further features from this drawing. Furthermore the person skilled in the art recognises that advantages may also result from a combination of several features shown in individual drawings or in different drawings.

### LIST OF REFERENCES

1 system/transforming device
6 base support
8 transforming stations
10 plastic parisons
12 station support
14 blow mould device
14a, 14b side parts of the blow mould device
14c base part of the blow mould device
15 blow mould shell
15a delivery and discharge element for temperature control medium
16 blow mould support
16a, 16b blow mould support parts
18 housing
18a cutting
20 plastic containers
22 control device for controlling the changing device
32 wall
34 wall parts
36 delivery device
38 discharge device
40 changing device
40a-40d changing device
42 control device for controlling the transforming device
46 detecting device
50 kiln
52 gripping device
53 gripping device
54 second swiveling arm
56 first swiveling arm
58 carrier
62 guide element
63 cutout
64a, 64b projections
66 projections
70 magazine device
72 holes
74 carrier/pallet
75 support plate
77 openings
78 carrier
79 base support
79a openings/holes
82 locking device
120, 130 drives
140, 145 magazine
122, 124 communication connections
132, 134 communication connections
142, 154 connections
150 identification element
160 separating element
172, 174 side parts
176 base part
182 holding device
184 carrier
192, 193 identification device
D axis of rotation
Dr axis of rotation of the gripping devices
B user
A1-A6 axes
W changing position
R radial direction
S1 first protection region
S2 second protection region

1. System for transforming plastic parisons to plastic containers with a transport device which transports the plastic parisons along a predetermined transport path, wherein the transport device has a movable station support on which a plurality of transforming stations are arranged, wherein these transforming stations each have blow mould devices which each form cavities within which the plastic parisons can be transformed into the plastic containers and these blow mould devices are each disposed on blow mould supports, and the system has a changing device which is suitable and intended in order at least to remove the blow mould devices from their blow mould supports and/or to arrange blow mould devices on the blow mould supports, wherein the changing device has an identification device for identifying blow moulds and/or blow mould parts, wherein the identification device preferably has an RFID detection device.

2. System according to claim 1, wherein at least one blow mould device has an RFID element which can be read by an RFID detecting device.

3. System according to claim 1, wherein the changing device has at least two gripping devices for gripping blow mould devices, wherein at least one of these two gripping devices is suitable both for gripping blow mould devices formed of a plurality of blow mould parts and also for gripping individual blow mould parts.

4. System according to claim 3, wherein both gripping devices are suitable both for gripping blow mould devices formed of a plurality of blow mould parts and also for gripping individual blow mould parts.

5. System according to claim 3, wherein the two gripping devices are arranged on a common rotatable and/or pivotable carrier.

6. System according to claim 3, wherein the changing device has a position detecting device for detecting a geometric position of blow moulds and/or blow mould parts.

7. Method for operating a transforming device for transforming plastic parisons to plastic containers, wherein in a working operation of the system the plastic parisons are transported by means of a plurality of transforming stations along a predetermined transport path and are expanded by application of a flowable medium to form the plastic containers, wherein for expanding the plastic parisons blow mould devices are used, in the interior of which the plastic parisons are expanded to form the plastic containers, wherein in a changing mode at least one of the blow mould devices of the system is removed and/or one of the blow mould devices is disposed on a blow mould support of the system, wherein for changing the blow mould devices a changing device is used and by means of at least one identification device at least one part of at least one blow mould device to be changed is identified.

8. Method according to claim 7, wherein at least one gripping device grips at least one blow mould device in an upper region relative to a longitudinal direction of the blow mould device.

9. Method according to claim 7, wherein the changing device grips a plurality of blow mould parts by means of two gripping devices.

10. Method according to claim 7, wherein blow mould devices are removed from transforming stations, wherein a removal movement perpendicular to a longitudinal direction of the blow mould parts takes place at least temporarily

11. Method according to claim 7, wherein a position of at least one blow mould device is detected.

12. Method according to claim 7, wherein at least one gripping device is equipped alternately with a blow mould device to be removed from the transforming station and a blow mould device to be arranged on the transforming station.

13. Method according to claim 7, wherein base parts of the blow mould device are turned with respect to an axis which is perpendicular to a longitudinal direction of the containers.
